(19) United States
(12) Patent Application Publication
(10) Pub. No.: US 2011/0031121 A1
(43) Pub. Date: Feb. 10, 2011

(54) PLASTIC SUPPORT FOR ELECTROPHORESIS GELS

(76) Inventor: Hafid Mezdour, Villeneuve D'Ascq (FR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/937,702

(22) PCT Filed: Apr. 14, 2008
(86) PCT No.: PCT/IB2008/053129

§ 371 Date: Oct. 13, 2010

(51) Int. Cl. G01N 27/447

(52) U.S. Cl. 204/467; 204/620; 204/618; 204/466

(57) ABSTRACT

According to a first aspect, the invention relates to a support (1, 10) for an electrophoretic gel film comprising a first film (2) having a plurality of lips formed by stamping, the lips forming a plurality of retention points for an electrophoretic gel film to be received on the support. The invention also relates to an electrophoretic element for use in electrophoretic separations, comprising the support according to the first aspect, coated with an electrophoretic gel film, as well as to the use of such an electrophoretic element.

### BACKGROUND OF THE INVENTION

### 1. Field of the Invention

The invention relates to electrophoresis and more particularly to a support for electrophoretic gel films and a method using it in electrophoretic process.

2. Description of Related Art

Electrophoresis is a well-known technique for the separation of biomolecules by utilizing their differences in rate of migration under the influence of an electrical field.

Gel electrophoresis makes use of a thin gel film coated on a suitable support, commonly glass or plastic, the biomolecules to be migrated being poured into wells formed in the gel film. The support should notably provide adequate retention of the gel film especially during manipulation, while maintaining transparency in order to visualize the migration pattern of the electrophoresis process.

Known supports for electrophoretic gel films, such as the GelBond® film from Lonza, comprise a transparent flexible plastic film and an adherent coating layer applied on the plastic film. Gels remains covalently attached to the support by means of the chemical agents of the adherent layer coated on the plastic film. However, as fabrication of such supports requires chemical treatment of the plastic film, such supports are relatively costly.

Furthermore, the plastic material of the support may interfere with some detection systems (UV systems in particular), which may impair the quality of the analysis. Indeed, visualization of the biomolecules present in the gel is generally performed by excitation of the fluorophores associated with biomolecules, but plastic affects the transmission of the UV light necessary for such excitation.

In addition, as the gel is firmly attached to the coasting on the plastic film:
first, it may prove difficult to excise selected portions of the gel that are required for analysis or purification (typically portions of the gel containing an electrophoretic pattern further to the migration of biomolecules);
second, as plastic is non porous, it constitutes an obstacle to the potential transfer of the biomolecules from the gel to a membrane, for instance made of nylon or nitrocellulose) under the action of an electrical field (this procedure, known as “electroblotting”, allows for obtaining a fingerprint of the biomolecules separation pattern and proves essential in the Southern blotting technique for DNA, in the Nothern blotting technique for RNA, and in the Western blotting technique for proteins).

It is an object of the present invention to provide a simpler and therefore cheaper support for electrophoretic gel films, in particular a support which does not need chemical treatment to provide sufficient attachment of the gel film (for instance a polymer gel, such as agarose or polyarylamide).

It is another object of the invention to facilitate the analysis of the migration by avoiding the interferences of the plastic material.

It is a further object of the invention to facilitate the excision of selected portions of the gel and the electro-transfer of the biomolecules from the gel to a membrane.

### SUMMARY OF THE INVENTION

In this context, the invention proposes in a first aspect a support for an electrophoretic gel film comprising a first film having a plurality of lips formed by stamping, the lips forming a plurality of retention points for an electrophoretic gel film to be received on the support.

Other preferred but non limitative aspects of this support are as follows:
the first film has at least one region with no lips defining a migration zone;
the support further comprises a second film on the first film, and the first and second films are mechanically attached by means of lips formed by stamping both films together;
the second film has at least one window defining a migration zone;
the second film has a central window or a plurality of elongated windows;
the second film has a scale along the at least one window;
the aperture of a lip with respect to the plane formed by the support is comprised between 35° and 40°;
the films are flexible plastic films;
the first film is transparent to ambient light or opaque to UV-blue light;

The invention also relates to a support for an electrophoretic gel film, comprising a first film, a second film having at least one window defining a migration zone bonded onto the first film, and an adherent coating layer applied to the second film, so that in use when the gel is deposited onto the support, the gel remains covalently attached to the support by means of the chemical agents of the adherent layer on the second film but is not attached to the support in the migration zone.

According to a second aspect, the invention proposes an electrophoretic element for use in electrophoretic separations, comprising the support according to the first aspect of the invention coated with an electrophoretic gel film, for instance an agarose gel film.

According to a third aspect, the invention proposes the use of the electrophoretic element according to the second aspect for effecting migration of a biomolecule by electrophoresis.

### BRIEF DESCRIPTION OF THE DRAWINGS

Other characteristics, purposes and advantages of the invention will appear to the reading of the following detailed description, with respect to the annexed drawings, given as non restrictive examples, in which:

FIGS. 1a, 1b and 1c respectively show a second film, a first film and a possible embodiment of the support of the invention composed of the first and second films of FIGS. 1a and 1b;

FIGS. 2a and 2b respectively shows a second film, and another possible embodiment of the support of the invention composed of the first film of FIG. 1a and of the second film of FIG. 2b;

FIGS. 3a-3c illustrates the stamping of both first and second films together to attach them by means of lips;

FIG. 4 shows a lateral view of a lip obtained by the stamping of FIGS. 3a-3c;

FIGS. 5a and 5b are top view showing possible embodiments of a lip;

FIGS. 6a-6c illustrates the stamping of both first and second films together to attach them by means of double-lips;

FIG. 7 shows a lateral view of a double-lip obtained by the stamping of FIGS. 6a-6c

FIG. 8 shows the first and second films mechanically attached by means of lips

FIGS. 9a-9d show various possible lip patterns;

FIG. 10 shows an electrophoretic element obtained from a support according to the first aspect of the invention.

### DETAILED DESCRIPTION OF THE PREFERRED EMBODIMENTS

According to its first aspect, the invention relates to a support for an electrophoretic gel film.

According to a first embodiment, the support comprises a first film having a plurality of lips formed by stamping, the lips forming a plurality of retention points for an electrophoretic gel film to be received on the support.

The formation of the lips and their functionality will be described in greater length with respect to the second embodiment. Anyhow, it will already be understood that the gel film to be coated on the support will not be covalently attached to the support, but rather mechanically retained on the support thanks to the lips so that it can be easily removed from the support when necessary (for instance for avoiding interferences during UV visualization or for facilitating the excision of selected portions of the gel).

According to a variant to this first embodiment, the first film has at least one region with no lips, defining a non-stamped migration zone. The first film can have a central non-stamped region, or a plurality of elongated non-stamped regions.

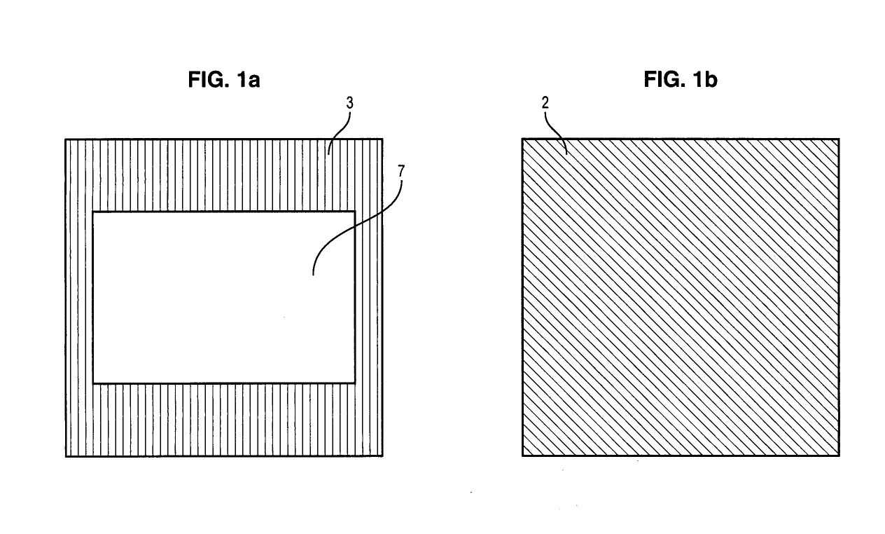

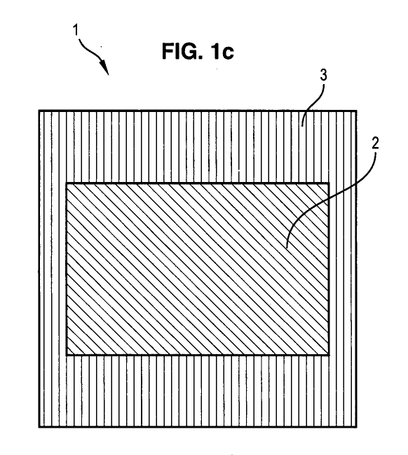

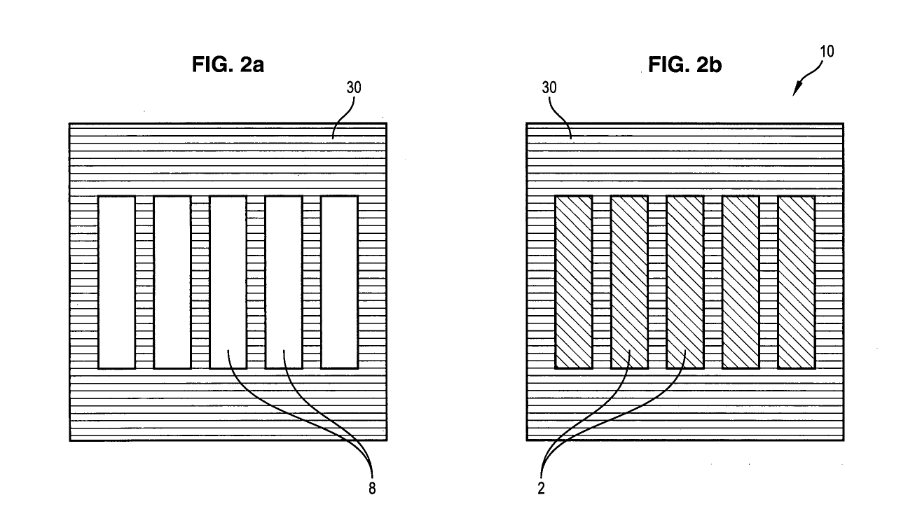

According to a second embodiment shown on FIGS. 1a-1c and on FIGS. 2a-2b, the support 1, 10 comprises a first film 2 and a second film 3, 30 on the first film 2.

In these two embodiments, the film(s) can be made of plastic material, for instance polyester. The plastic material is preferably a flexible plastic exhibiting certain rigidity.

Further to allowing the use of gel films in non immersed conditions, the flexibility allows positioning the gel and its support upon an arch linking the two buffer solution baths of the electrophoresis system with no need for paper bridges (known as paper wicks) to ensure the electrical conductivity. The flexibility of the support indeed allows for the lateral portions of the gel film to dip within the buffer solution baths, in particular when the support is placed upon an arch of 2-3 cm central height.

The first and second films have substantially the same size, for instance 125 mm*125 mm.

As a non limitative example, the support is 0.2 mm thick with the thickness of the first film 2 being 0.075 mm and the thickness of the second film 3, 30 being 0.125 mm.

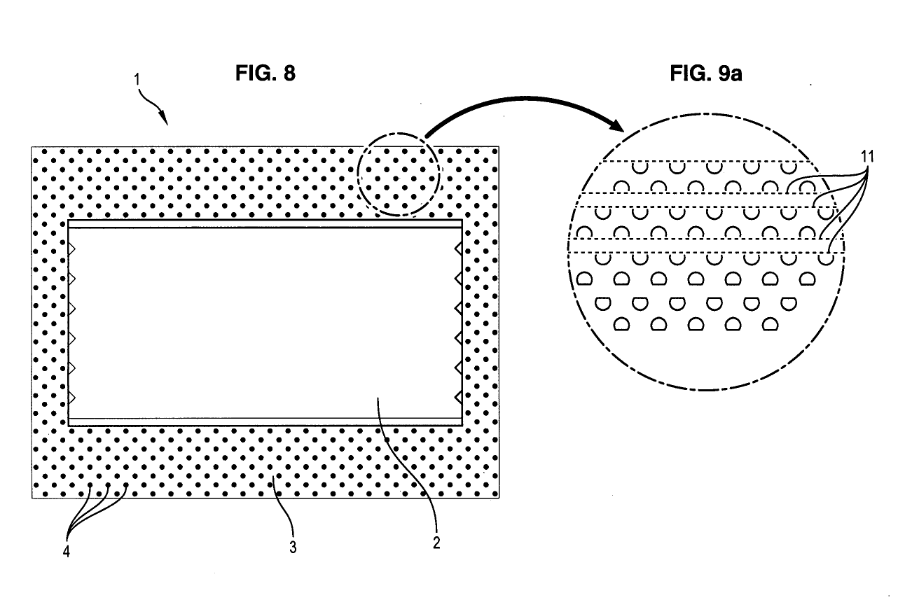

As shown for instance on FIG. 8, the first and second films are mechanically attached by means of lips formed by stamping both films together. It has to be noted that the lips form a plurality of retention points for an electrophoretic gel film to be received on the support.

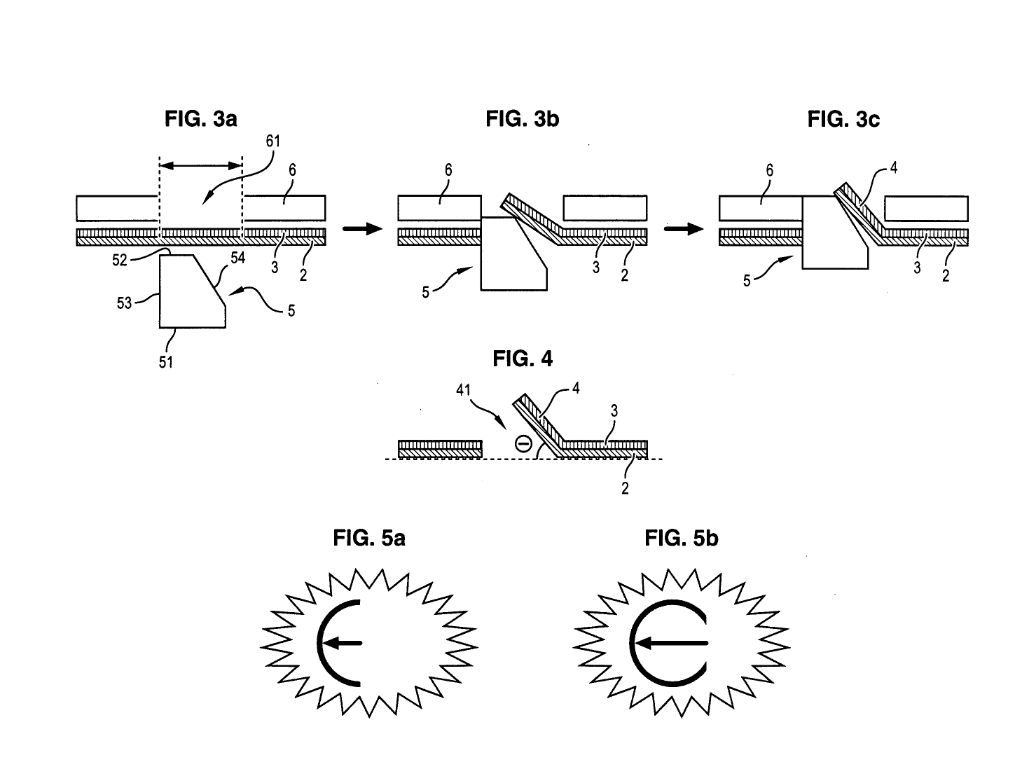

FIGS. 3a-3c illustrates a possible stamping process for mechanically attaching the films together using a punch 5 and a base plate 6. It will be understood that this process is also applicable to the formation of the lips in the context of the first embodiment.

The base plate 6 has a plurality of holes 61 defining a particular pattern for the formation of the lips.

The punch 5 has a base surface 51, a top surface 52 which in cross-section is smaller than the hole 61 in the base plate, a first straight lateral surface 53 and a second tipped lateral surface 54.

The two films 2, 3 are positioned on the underside of the base plate. Then the punch 5 is directed towards the films so as to perforate them as shown on FIGS. 3a-3c, thereby forming a lip 4 integrally formed from the two films.

As shown on FIG. 4, the lip extends from the plane formed by the films and thereby forms a recess 41 which will define a retention point for an electrophoretic gel to be received on the support.

The aperture 8 of a lip 4 with respect to the plane formed by the support is preferably comprised between 35° and 40°.

As shown on FIGS. 5a and 5b, the punch 5 and the base plate 6 can be configured so as to define semi-circular lips in the support (FIG. 5a) or three-quarter circular lips in the support (FIG. 5b).

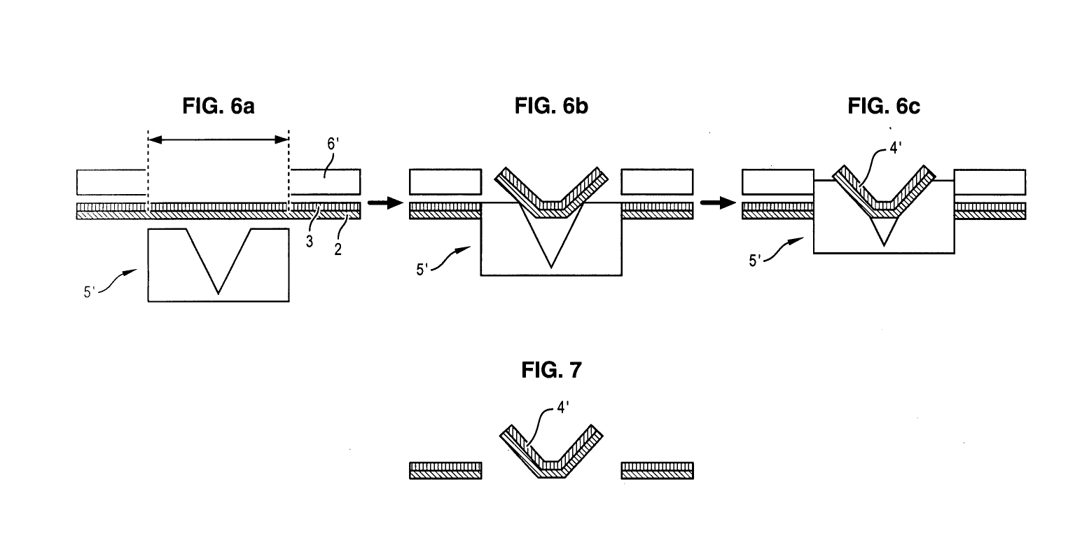

FIGS. 6a-6c illustrates a possible stamping process for mechanically attaching the film together by means of a base plate 6′ and of a punch 5′ having a M-shaped cross-section. The base plate 6′ and the punch 5′ are configured to allow the formation of two adjoining lips having opposite aperture, here called double-lips 4′.

It will be understood that the invention is not limited to a particular lip shape, as various punch and base plate configuration can be used so as to form recesses serving as retention points for mechanically attaching a gel film onto the support. Furthermore, the stamping of the film(s) could also be performed along with a heating of the film(s) capable of deforming the film(s) so as to form lips of more complex shapes.

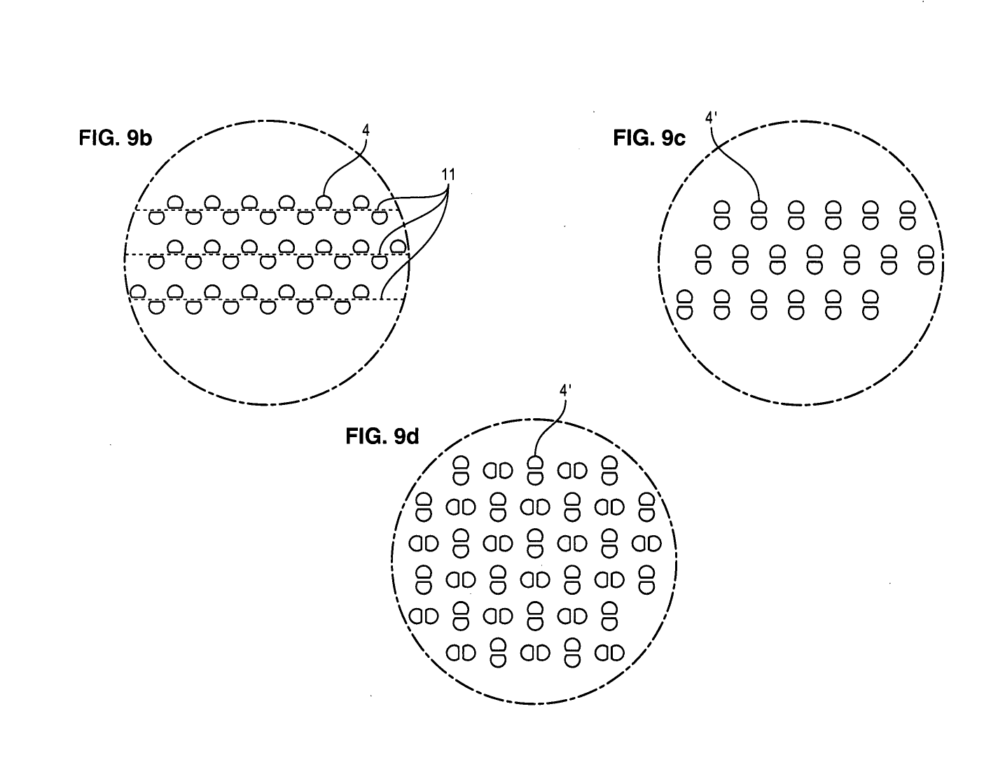

FIGS. 9a-9d shows various lip patterns formed by stamping the film(s).

The lips are generally distributed along parallel lines, as illustrated by dotted lines 11 on FIGS. 9a and 9b.

As shown on FIGS. 9a (and 9c in case of double lips 4′), the lips (or double lips 4′) of a line 11 can all have the same orientation, that is they are all formed so that their aperture is directed in the same direction.

As also shown on FIG. 9a, the orientation of the lips can alternate in between adjacent lines 11.

As shown on FIGS. 9b and 9d, the lips 4 or double-lips 4′ of a line 11 can have alternating orientation.

It will be noted that the lips pattern of FIG. 9a-9c may prevent detachment of the gel film from the support and disunion of the first and second films in the direction perpendicular to the parallel lines 11, while the lip pattern of FIG. 9d may prevent detachment of the gel film from the support and disunion of the first and second films in both directions.

The invention also relates to an electrophoretic element for use in electrophoretic separations, comprising the support 1, 10 according to the first aspect of the invention coated with an electrophoretic gel film (for instance 3 mm thick), for instance an agarose gel film. It will be noted that the gel attaches efficiently to the support thanks to the lips, each lip indeed defining a recess acting as a retention point for the gel.

It will further be noted that the mechanical attachment of the invention allows for a possible detachment of the first film either from the gel film in the first embodiment or from the second film in the second embodiment. The first film can thus form a detachable protector film to protect the gel from dehydration during electrophoresis in non immerged conditions.

The support of the invention has the following advantages:
it compensates the fragility of gels in handling and facilitates certain stages of manipulation (staining, discoloration, transfer, etc.);
it can be used in all electrophoresis systems (with the gel being immersed or non-immersed in the buffer solution, with the support being in normal or inverted position, upon an horizontal support or a rounded support);
it allows for easy removal of the support and for possible cutting of the gel if needed.

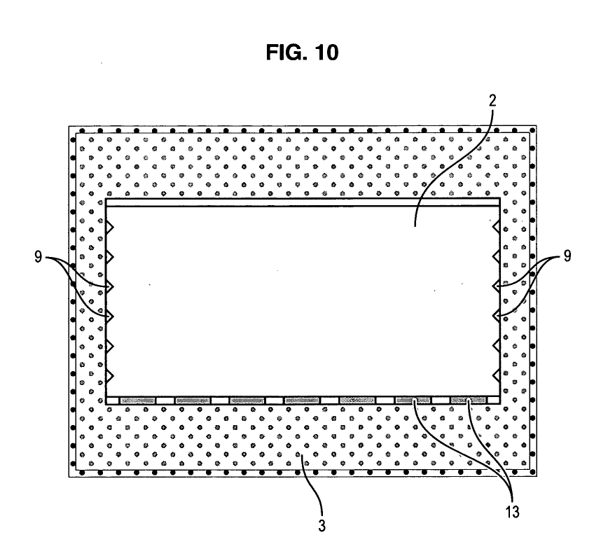

According to a preferred embodiment of the invention, at least one window is hollowed out in the second film 3, 30, said window defining a migration zone, or in other words a useful area for the migration during electrophoresis of the substances poured into wells 13 (see FIG. 10) in the gel film. Such a migration zone can be formed in the first embodiment by having a non-stamped region in the first film.

As shown on FIG. 8, a scale 9 may be provided on the second film along the at least one window, so as to help in the analysis of the electrophoresis.

In a first variant shown on FIG. 1a, the second film 3 has a central window 7 defining a central migration zone for all the substances to be migrated. Reverting to the above mentioned non limitative example, the central window 7 is for instance a rectangle of width 82 mm and of length 102 mm.

FIGS. 1c and 8 both show the support 1 formed by attaching the first film 2 of FIG. 1b with the second film 3 of FIG. 1a having a central window 7.

In a second variant shown on FIG. 2a, the second film 30 has a plurality of elongated window 8, each window defining a migration zone for instance for the migration of a particular substance poured in a single well 13.

Reverting to the above mentioned non limitative example, each window 8 is a rectangle of width 15 mm and of length 40 mm.

FIG. 2b shows the support 10 formed by attaching the first film 2 of FIG. 1b with the second film 30 of FIG. 2a having a plurality of elongated windows 8.

In the context of this preferred embodiment, the support 1, 10 thus presents a stamped zone corresponding to the zone where the two films are mechanically attached, and at least one non stamped zone corresponding to a window in the second film and thus only formed of a portion the first film (not stamped as it has no portion of the second film on it).

In the case of a single central window being hollowed out in the second film, the non stamped zone forms a central zone whereas the stamped zone forms a strip around the central zone.

When the electrophoretic gel film is deposited onto the support according to this preferred embodiment, the gel will attach to the stamped zone but will not adhere to the non punctured zone in the at least one migration zone defined by the at least one window in the second film.

Another solution for having the gel not attached to the support in the migration zone is described hereafter. The support for the gel film comprises a first film, a second film having at least one window defining a migration zone bonded onto the first film (for instance using silicone), and an adherent coating layer applied to the second film, so that in use when the gel is deposited onto the support, the gel remains covalently attached to the support by means of the chemical agents of the adherent layer on the second film but is not attached to the support in the migration zone.

In the case of a single central window being hollowed out in the second film, it will be appreciated that the non-chemically treated zone forms a central zone whereas the chemically treated zone (where the adherent coating layer is applied) forms a strip around the central zone.

Known adherent coating layers are for instance described in U.S. Pat. No. 4,415,428 which shows procedures for the adhesion of natural (agarose) or synthetic (polyacrylamide) polymer gel films on a support. U.S. Pat. No. 4,415,428 for instance describes coating a plasma activated polyester film with allyglydidylagarose.

Other non limitative examples of adherent coating layers can be found in the following references: EP 119 090 (which shows a polymer having a particular formula), EP 126 638 (a slightly different polymer), EP 162 657 (cellulose derivative), EP 163 472 (methyl-methacrylate macromonomer derivative), EP 246 751 (resin having a low oxygen permeability), EP 167 373 (inorganic oxide), EP 246 873 (gelatine) and EP 155 833 (nonconductive metal oxide layer).

In both above mentioned solutions, as the gel is not attached to the support in the migration zone, the gel portions in which the biomolecules have migrated can easily be excised from the support for subsequent purification.

The gel content can also be easily transferred under the action of an electrical field onto a membrane of nylon or nitrocellulose, after the first has been removed.

Furthermore, polyester is opaque to wavelengths lower than 300 nm, that is those wavelengths which are classically used for detection of the fluorophores associated to DNA. But in the invention, the first film forms a detachable protector film. Thus when the first film is detached, the opacity problem is avoided and the analysis of the migration can be facilitated.

The first film is advantageously transparent to ambient light or opaque to UV-blue light (the film is for instance a yellow-orange translucent plastic film) so that an image of the gels portions in which the substances migrate can easily be obtained with a camera or a UV transilluminator.

In the case a yellow orange film is used, the gel is positioned so as to face the transilluminator. The yellow orange film blocks the UV-blue emitted by the transilluminator but let the other wavelengths pass (in particular those emitted by the fluorophores associated with the biomolecules and excited by the UV-blue).

1. Support (1, 10) for an electrophoretic gel film comprising a first film (2) having a plurality of lips formed by stamping, the lips forming a plurality of retention points for an electrophoretic gel film to be received on the support.

2. Support (1, 10) according to claim 1, wherein the first film (2) has at least one region with no lips defining a migration zone.

3. Support (1, 10) according to claim 1, further comprising a second film (3, 30) on the first film and wherein the first and second films are mechanically attached by means of lips (4, 4′) formed by stamping both films (2; 3, 30) together.

4. Support according to claim 3, wherein the second film has at least one window (7, 8) defining a migration zone.

5. Support according to any preceding claims, wherein the aperture (8) of a lip with respect to the plane formed by the support is comprised between 35° and 40°.

6. Support for an electrophoretic gel film, comprising a first film, a second film having at least one window defining a migration zone bonded onto the first film, and an adherent coating layer applied to the second film, so that in use when the gel is deposited onto the support, the gel remains covalently attached to the support by means of the chemical agents of the adherent layer on the second film but is not attached to the support in the migration zone.

7. Support according to claim 4 or claim 6, wherein the second film has a central window (7) or a plurality of elongated windows (8).

8. Support according to claim 4 or claim 7, wherein the second film has a scale (9) along the at least one window (7, 8).

9. Support according to any preceding claims, wherein the films are flexible plastic films.

10. Support according to any preceding claims, wherein the first film (2) is transparent to ambient light or opaque to UV-blue light.

11. Electrophoretic element for use in electrophoretic separations, comprising the support (1, 10) according to any one of claims 1 to 10, coated with an electrophoretic gel film, for instance an agarose gel film.

12. Use of the electrophoretic element according to the preceding claim for effecting migration of a biomolecule by electrophoresis.
